(19) United States
(12) Patent Application Publication
(10) Pub. No.: US 2011/0309970 A1
(43) Pub. Date: Dec. 22, 2011

(54) SYSTEM FOR DETECTING A POSITION OF AN OBJECT IN A PLANE

(75) Inventors: Wilhelmus Johannes Franciscus Fontijn, Eindhoven (NL); Willem Bastiaan van Rossem, Geldrop (NL)

(73) Assignee: SERIOUS TOYS B.V., 's-Hertogenbosch (NL)

(21) Appl. No.: 13/144,231

(22) PCT Filed: Jan. 15, 2010
(86) PCT No.: PCT/NL10/50019

§ 371 Date: Sep. 9, 2011

(30) Foreign Application Priority Data
Jan. 16, 2009 (EP) 09150803.6

(51) Int. Cl. G01S 13/06

(52) U.S. Cl. 342/146

(57) ABSTRACT

The system for detecting a position of an object in a plane (2), comprises in an operational state
at least one antenna loop (10D+10E) aligned with the plane (2),
an RF signal generator (41) for activating the antenna loop.

The antenna loop has at least one antenna element (10D, 10E) with a cross-diameter (H) in a direction transverse to the plane that is larger than a cross-diameter (D) in a direction aligned with the plane.

Alternatively or in addition the system for detecting a position of an object in a plane comprises in an operational state
at least a first antenna loop (210D+210E),
at least a second antenna loop (210C+210F), that extends at least partially outside the first antenna loop,
an RF-signal generator (241) for providing the first antenna loop with an RF signal,
an facility (243, 244) for providing the second antenna loop with an RF signal that is in phase with that of the RF-signal in the first antenna loop.

### BACKGROUND

1. Field of the Invention

The present invention relates to a system for detecting a position of an object in a plane.

2. Related Art

Sensing systems for localizing an object provided with an RFID tag are known. For instance, objects with built-in RFID tags can be cheaply localized in specific positions on a shelf or at specific terminals of a robotic delivery system, which shelves or terminals comprise an arrangement of antenna loops. Separate antennas in the arrangement of sensing antenna loops are subsequently activated by an RF signal. Likewise positions of objects on a gameboard can be detected in this manner. Each specific position is defined by the intersection of one row antenna loop with one column antenna loop.

An activated antenna loop radiates a radio frequency (RF) signal at an operating frequency of the RFID tag of a token of which the position is to be detected. This RF signal is received by an internal antenna of the RFID tag where it, in case of a passive RFID tag provides for the power of the RFID tag. The RFID tag subsequently transmits a response signal which is received by the activated antenna loop and converted to the detection signal by which it is derived that the token is present in the area covered by the activated antenna loop. The response signal of the RFID tag may also comprise information from which a specific identity code of the RFID tag can be derived. This allows for the detection of a plurality of RFID tags.

In an alternative embodiment the RFID tag does not actively transmit a response signal, but instead it changes the absorption of the RF signal in a specific way and thereby changes the antenna load of the activated antenna loop. The specific change of the antenna load by the RFID tag is a measure for the specific identity code of the RFID tag.

Ideally the token is detected when it is inside an activated antenna loop and the token is not detected otherwise. However, in practice it is observed with conventional systems on the one hand that the antenna loops have a dead zone, wherein tokens are not detected, and and on the other hand that tokens are sometimes falsely detected outside the antenna loop.

Accordingly there is a need to improve the detection accuracy.

### SUMMARY

It was recognized by the inventors that the field strength of the RF-field generated by the antenna loop changes relatively slowly from a position within the antenna loop to a position outside the antenna loop. Accordingly relatively small noise contributions may already have the effect that an object is detected when it should not be detected and the other way around.

According to a first aspect of the invention there is provided a system for detecting a position of an object in a plane, in an operational state comprising

at least one antenna loop aligned with the plane,

an RF signal generator for activating the antenna loop,

wherein the antenna loop has at least one antenna element with a cross-diameter in a direction transverse to the plane that is larger than a cross-diameter in a direction aligned with the plane.

This lengthens the path of the magnetic field lines inside the loop. This results in an enhanced homogeneity within the antenna loop while causing a greater dispersion (thus weakening the field) in the area next to the antenna loop. The result is a substantial improvement in the difference between the field strengths above the active antenna and next to that area.

Additionally, as the antenna elements have a cross-diameter in a direction transverse to the plane that is larger than a cross-diameter in a direction aligned with the plane, the antenna elements have a higher surface area than would be the case for antenna elements having a circular profile with the same cross-sectionional area. This is advantageous as the skin-effect is relatively strong for RF-frequencies. I.e. the surface of the antenna elements provides the most important contribution to their conductivity. If the ratio H/D is relatively high, low resistive losses are achieved while the cross section of the antenna elements can have a modest area.

According to a second aspect of the invention there is provided a system for detecting a position of an object in a plane, in an operational state comprising

at least a first antenna loop,

at least a second antenna loop, that extends at least partially outside the first antenna loop,

an RF-signal generator for providing the first antenna loop with an RF signal,

an facility for providing the second antenna loop with an RF signal that is in phase with that of the RF-signal in the first antenna loop. The electro-magnetic field generated by the first antenna loop outside the first antenna loop is in counter-phase with the field inside the first antenna loop. Hence, as the second antenna loop generates in its inside an electro-magnetic signal that is in phase with the field inside the first antenna loop it partially annihilates the electro-magnetic field in the zone between the first and the second antenna loop, where the second antenna loop extends beyond the first antenna loop. A complete annihilation is not necessary . It is sufficient if the field outside the first antenna loop is just sufficiently weakened to prevent operation of a tag placed in that region. In that way the field within the first antenna loop is substantially unchanged by the presence of the second antenna loop.

Accordingly both measures result in a steeper reduction of the magnetic field in the area directly outside the (first) antenna loop. This results in a substantial improvement in the difference between the field strengths above the active antenna loop and next to that area. Due to this clear difference in field strength, noise has less influence on the detection.

### BRIEF DESCRIPTION OF THE DRAWINGS

These and other aspects are described in more detail with reference to the drawing. Therein:

FIG. 1 schematically shows a gaming device according to the present invention,

FIG. 2 shows a further device according to the present invention,

FIG. 3 shows a prior art antenna array for RFID based position detection,

FIG. 4 shows a first embodiment of a detection system according to the present invention,

FIG. 4A shows a cross-section according to IVA-IVA in FIG. 4,

FIG. 5A shows a magnetic field in an antenna loop of a prior art antenna array,

FIG. 5B shows a magnetic field in an antenna loop of a detection system according to the present invention,

FIG. 6A shows a first example of mutually crossing antenna elements in a detection system according to the present invention,

FIG. 6B shows a second example of mutually crossing antenna elements in a detection system according to the present invention,

FIG. 6C shows a third example of mutually crossing antenna elements in a detection system according to the present invention,

FIG. 7 shows the embodiment of FIG. 6B in more detail,

FIG. 7A shows elements of FIG. 7 in still more detail,

FIG. 8 shows a part of an antenna array in a second embodiment of a detection system according to the present invention,

FIG. 8A shows a cross-section of the second embodiment,

FIG. 9A shows a first alternative way of providing mutually crossing antenna elements in the second embodiment,

FIG. 9B shows a second alternative way of providing mutually crossing antenna elements in the second embodiment,

FIG. 10 shows a third embodiment of a position detection system according to the present invention,

FIG. 10A shows a magnetic field in an antenna loop of a detection system according to the present invention, according to cross-section XA-XA in FIG. 10,

FIG. 11 shows an alternative implementation of this third embodiment,

FIG. 11A shows a detail of FIG. 11,

FIG. 12 shows circuitry used in the third embodiment in more detail,

FIG. 13 shows a fourth embodiment of a position detection system according to the present invention,

FIG. 14 shows a fifth embodiment of a position detection system according to the present invention.

### DETAILED DESCRIPTION OF EMBODIMENTS

In the following detailed description numerous specific details are set forth in order to provide a thorough understanding of the present invention. However, it will be understood by one skilled in the art that the present invention may be practiced without these specific details. In other instances, well known methods, procedures, and components have not been described in detail so as not to obscure aspects of the present invention.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, and/or sections, these elements, components, and/or sections should not be limited by these terms. These terms are only used to distinguish one element, component or section from another element, component, and/or section. Thus, a first element, component, and/or section discussed below could be termed a second element, component, and/or section without departing from the teachings of the present invention. In the following description the wording first and second antenna loop will be used to distinguish between the primary antenna loop for generating a magnetic field and a secondary antenna loop to attenuate the magnetic field outside the primary antenna loop. If a secondary antenna loop is absent, the wording antenna loop will also be used to denote the primary antenna loop.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. All publications, patent applications, patents, and other references mentioned herein are incorporated by reference in their entirety. In case of conflict, the present specification, including definitions, will control. In addition, the materials, methods, and examples are illustrative only and not intended to be limiting.

FIG. 1 is a schematic drawing of an example of an embodiment of a game device 1 according to the invention. FIG. 1 shows a game device 1 with a gaming board 2 forming a plane with axis x, y in a 3D space x,y, z and a number of game pieces 4, 5. Further drawings are shown with reference to this coordinate system. For the sake of clarity, only two game pieces 4, 5 are shown in FIG. 1; however, any appropriate number could be used with the game. The gaming board 2 may have a pattern 3 on the surface facing upwards, so that the game pieces 4, 5 may be placed within the pattern. The game device 1 moreover comprises a sensing system (not shown) embedded or integrated within the gaming board 2. The sensing system of the game device is provided with RF detection means for detecting the presence of a tag within game pieces 4, 5. Moreover, the board may be arranged for initiating outputs, such as LED light, audio output, etc. The game device 1 moreover comprises processor means (not shown) arranged for receiving sensor inputs in the detection of user moves made by a player in relation to a game, tracing user moves, deriving a pattern of user moves and comparing the pattern with a specific pattern in order to assess the skills of the player. In the above, it is understood that the moves of the player or user may be recognized by detecting where and when each game piece is placed on the gaming board 2.

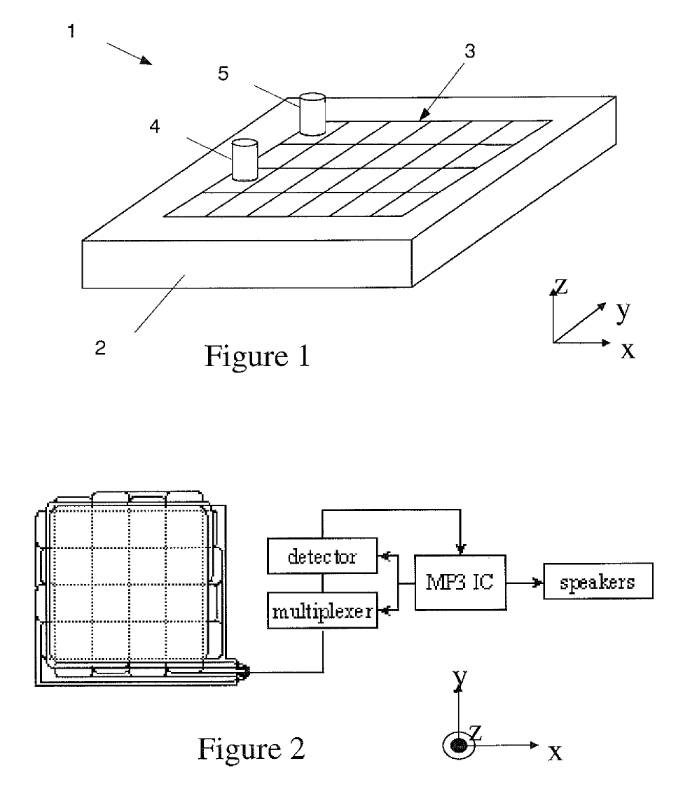

FIG. 2 shows another application wherein an RFID detection system is used to select an MP3 file to be reproduced by an MP3 player. The RFID position detection array is connected to at least one RFID detector via a multiplexer. The RFID detector is connected to an MP3 player IC (e.g. Melody). The application is running on the ARM core of the MP3 player IC. It controls the readout of the array via the detector and the multiplexer. The multiplexer selects which antenna element is connected to the detector and at which time. The array is periodically scanned to localize all tags on the array. The results are sent to the MP3 player IC and the application decides how to respond to these results, e.g. by playing a selected MP3 file.

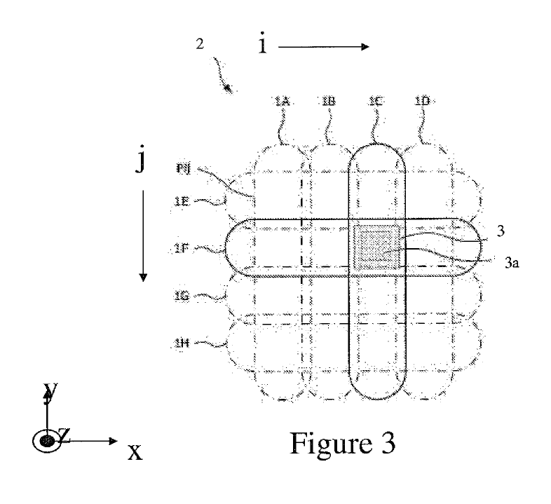

FIG. 3 schematically shows a prior art RF sensing system. The sensing system is intended for a game board 2 with sixteen scanning positions Pij arranged in a 4×4 matrix. A token 3 with a built-in RFID tag 3a is placed in one of these scanning positions Pij. The scanning positions Pij of the game board 1 are scanned by four antennas 1A-1D arranged adjacent to each other in a column configuration and by four antennas 1E-1H arranged adjacent to each other in a row configuration. First, all columns i are scanned by successively activating antennas 1A to 1D, querying whether one or more of the antennas 1A to 1D, corresponding to the first to fourth column, receive a signal from the RFID tag 3a. In this example only antenna 1C, which scans the third column, receives a signal from RFID tag 3a. Next, all rows j are scanned by successively activating antennas 1E to 1H, corresponding to the first to fourth row, querying whether one or more of these antennas 1E to 1H receives a signal from the RFID tag 3a. In this example only antenna 1F, which scans the second row, receives a signal from RFID tag 3a. The scanning position where the token 2 is present has thus been determined as being the scanning position P32.

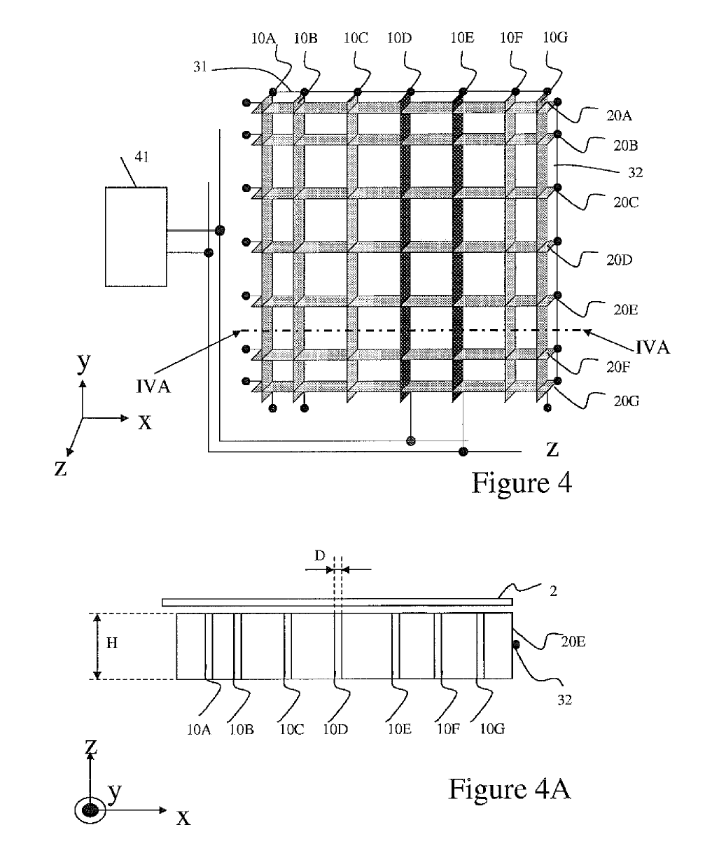

FIGS. 4 and 4A show a first embodiment of a system according to the present invention for detecting a position of an object (position detection system) in a plane, e.g. a plane 2 of a game board, which coincides substantially with the plane of the drawing of FIG. 4. FIG. 4A, shows a cross-section IVA-IVA of FIG. 4. The system shown in FIG. 4 comprises a plurality of parallel elongated antenna elements 10A-10G and a further plurality of parallel elongated antenna elements 20A-20G transverse to the plurality 10A-10G. The plurality of parallel elongated antenna elements 10A-10G are each coupled at a first end to a common interconnect line 31. The further plurality of parallel elongated antenna elements 20A-20G are each coupled at a first end to a further common interconnect line 32. Each pair of parallel elongated antenna elements 10A-10G forms together with the part of the common interconnect line 31 that connects them an antenna loop. Likewise, each pair of parallel elongated antenna elements 20A-20G forms together with the part of the common interconnect line 32 that connects them an antenna loop. In the sequel an antenna loop comprising antenna elements X,Y will be denoted as antenna loop X+Y, e.g. antenna loop 10D+10E comprises antenna elements 10D, 10E. In the situation shown in FIG. 4, the antenna loop formed by parallel elongated antenna elements 10D, 10E and their interconnect via interconnect line 31 forms the antenna loop that is activated by the RF-signal generator 41. The antenna loops formed in this way are aligned with the plane 2 in which a position has to be detected. The system is further provided with an RF signal generator 41 for activating the antenna loop. As can be seen in FIG. 4 the antenna loop has at least one antenna element 10D with a cross-diameter in a direction transverse to the plane that is larger than a cross-diameter in a direction aligned with the plane. FIG. 4A, showing a cross-section IVA-IVA of FIG. 4 further clarifies this aspect. In a direction aligned with the plane 1 the antenna elements, e.g. 10D have a cross-diameter equal to thickness D. In a direction transverse to the plane 1 the antenna elements have a cross-diameter equal to height H that is larger than the thickness D. This measure results in a longer path for the magnetic field lines. This enhances homogeneity within the antenna loop while causing a greater dispersion (thus weakening the field) in the area next to the antenna loop. This results in a substantial improvement in the difference between the field strengths above the active antenna and next to that area. The ratio H/D is for example in a range of 5 to 100. If the ratio is substantially less than 5, e.g. less than 2 a relatively insignificant improvement of said difference in field strength is obtained. If the ratio is substantially larger than 100, e.g. larger than 500 either the material of the antenna elements becomes so thin that it is difficult to handle, or the height of the antenna elements imposes requirements on the housing that are impractical. The height H of the antenna elements may further be selected dependent on a distance S between the antenna elements. For example the ratio H/S may be selected in a range between 0.1 and 1, for example a value of 0.5 may be choosen as the ratio H/S.

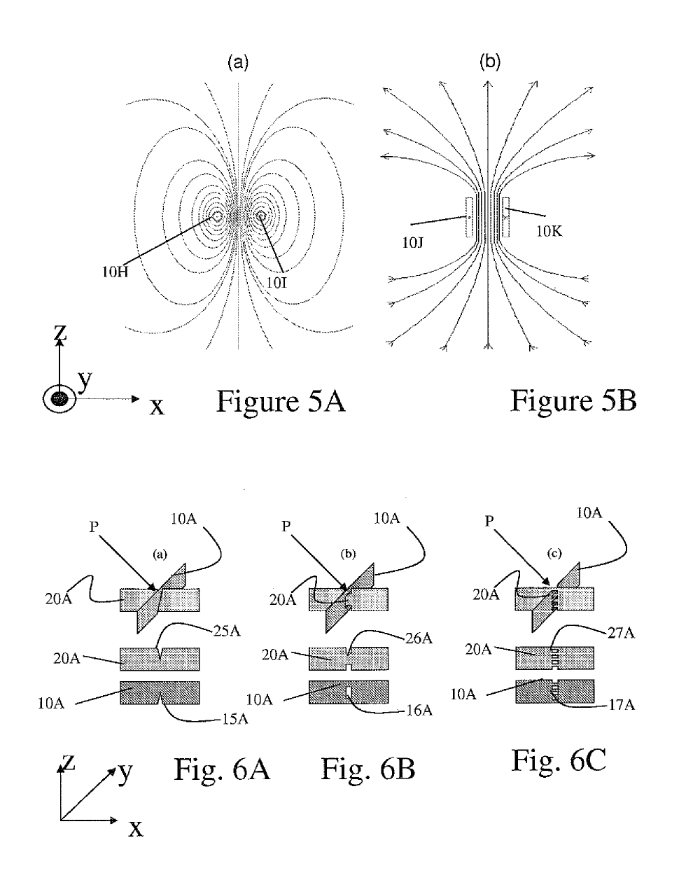

FIGS. 5A and 5B schematically illustrate this effect. FIG. 5A shows the magnetic field lines in a cross-section of a conventional antenna loop 10H+10I formed by a wire 10H, 10I having a circular cross-section. FIG. 5B shows magnetic field lines for a cross-section of an antenna loop 10J+10K in an embodiment of a detection apparatus according to the present invention. The conventional antenna loop of FIG. 5A shows a gradually increasing dispersion of the field lines. On the contrary, in the antenna loop of the inventive embodiment the dispersion of the magnetic field lines changes substantially more abrupt near the boundary of the region defined by the antenna loop 10J+10K. Accordingly it can be determined more precise whether the tag of the object to be localized is within or outside the antenna loop.

FIGS. 6A, 6B, 6C shows with various examples how mutually crossing antenna elements, e.g. 10A, 20A may be arranged. From bottom to top these Figures subsequently show a first antenna element 10A, a second antenna element 20A and the combination of these two elements 10A, 20A. In the example shown in FIG. 6A the antenna element 10A and the antenna element 20A are each provided with recesses 15A, 25A with which said antenna elements 10A, 20A grip into each other at their crossing point P. This is an advantageous embodiment, as it can be rapidly assembled. The antenna elements 10A, 20A are provided with an insulating coating so that they do not contact each other electrically in their crossing point P. In the example shown in FIG. 6B antenna element 10A has an opening 16A that gives access to a narrowed portion 26A of antenna element 20A. In the example shown in FIG. 6C, the antenna elements 10A, 20A are each divided into a plurality of fingers 17A, 27A. The fingers 17A of antenna element 10A and the fingers 27A of antenna element 20A extend between each other in the crossing point P.

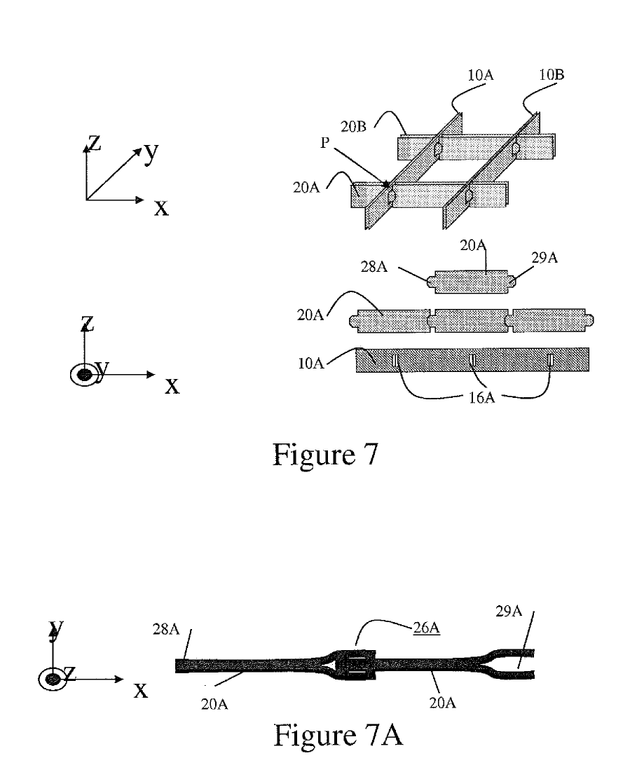

The antenna elements 10A, 20A as shown in FIG. 6A are preferred as they can be assembled by a placement operation in a single direction, here in the direction of the z-axis. The antenna elements 10A, 20A of FIGS. 6B and 6C can be assembled as shown in FIGS. 7 and 7A. FIG. 7 shows from bottom to top antenna element 10A, a set of chained antenna elements 20A, a single antenna element 20A and assembled antenna elements 10A, 10B, 20A, 20B. FIG. 7A shows in top view two chained antenna elements 20A. As shown in FIGS. 7 and 7A, the antenna elements 20A are formed by a double metal layer of a metal. The antenna elements have an ear 28A, 29A at each side. At one side the layers of the metal are folded apart, so that the layers of ear 29A can clamp the ear 28A of a next antenna element 20A after the ear 28A of said said next antenna element is arranged through the opening 16A of the antenna element 10. The ear 29A of an antenna element and the ear 28A of the next element form a narrowed portion 26A. In a similar way the fingers 27A of antenna elements 20A may clamp fingers of a next antenna element 20A and fingers 17A of antenna elements 10A may clamp fingers of a next antenna element 10A.

It is not necessary that all antenna loops are arranged in the same plane. A position detection system may be conceivable wherein different antenna loops are arranged in different planes, so that the planes may together approximate a more complex surface, e.g. a curved surface.

In the embodiments of the invention shown in the previous Figures, the antenna elements 10A, 20A etc. are formed by a single, blade shaped conductive body. This is however not necessary. An antenna element may be formed by more than one conductive body, provided that they conduct the current in the same direction and are simultaneously activated.

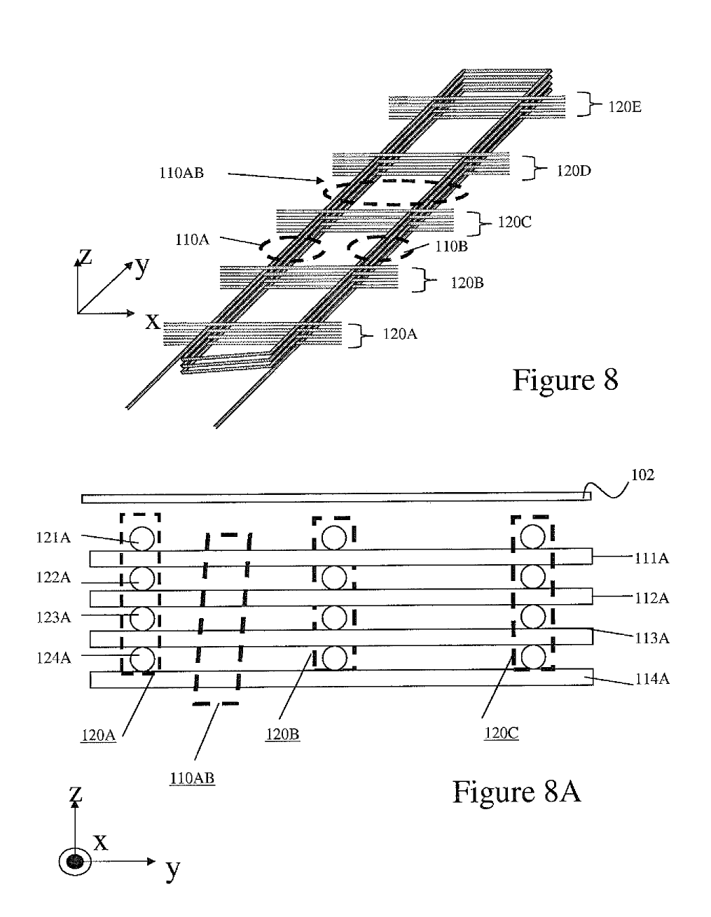

Parts in FIGS. 8 and 8A corresponding to those in FIG. 4 have a reference number that is 100 higher. FIGS. 8 and 8A shows a further embodiment wherein antenna loops, e.g. 110A+110B (110AB) are formed by a coil having antenna elements 110A, 11B with each a plurality of windings 111A-114A. FIG. 8 shows a part of the detection array in perspective view and FIG. 8A shows a cross-section in the y-z plane through one of the antenna elements 110A. The windings 111A-114A of antenna element 110A are stacked and interwoven with windings 121A-124A of other antenna elements 120A.

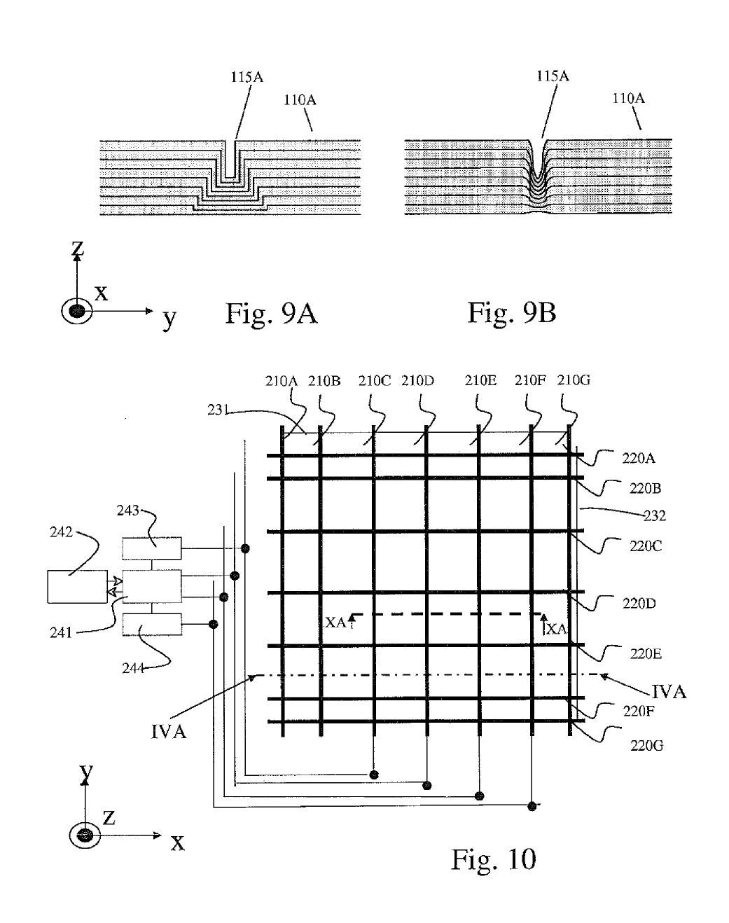

It is not necessary that the windings of mutually crossing antenna elements are interwoven with each other. FIGS. 9A and 9B show examples how antenna elements 110A formed out of a stack of wires may be provided with an indentation 115A that allows them to be assembled with other antenna elements in a way analogous as shown in FIG. 6A for blade shaped antenna elements 10A, 10B. In the example shown in FIG. 9A, the wires forming the antenna element are folded around a mold. In the example 9B the indentation is formed after the process of stacking the wires.

As discussed in the summary the desired improvement in the magnetic field strength distribution can alternatively be obtained by another embodiment of the invention that will now be discussed in more detail with reference to FIG. 10. Parts therein corresponding to those in FIG. 4 have a reference number that is 200 higher. In the embodiment shown in FIG. 10 the system of the invention has a first plurality of antenna elements 210A-210G having a circular cross-section and that extend in the y-direction. Likewise it has a second plurality of antenna elements 220A-220G having a circular cross-section and that extend in the x-direction.

As shown in FIG. 10, in this other embodiment, the system of the invention for detecting a position of an object in a plane, comprises besides at least a first antenna loop, in addition at least a second antenna loop, that extends at least partially outside the first antenna loop. In the operational state shown in FIG. 10, the first antenna loop 210D+210E comprises antenna elements 210D and 210E. The second antenna-loop 210C+210F comprises antenna elements 210C and 210F. In this other embodiment the system of the invention further comprises an RF-signal generator 241 for providing the first antenna loop 210D+210E with an RF signal and a facility 243, 244 for providing the second antenna loop 210C+210F with an RF signal that is in phase with that of the RF-signal in the first antenna loop 210D, 210E.

The controller 242 controls the RF-signal generator 241 and the facility 243, 244 for scanning the array of antenna elements 210A-210G, 220A-220G according to the scanning pattern of the following table. Therewith the sequence of states 1-8 is repeated. Alternatively another scanning pattern may be employed.

| | First antenna loop | | Second antenna loop | |
|---|---|---|---|---|
| state | element 1 | element 2 | element 1 | element 2 |
| 1 | 210B | 210C | 210A | 210D |
| 2 | 210C | 210D | 210B | 210E |
| 3 | 210D | 210E | 210C | 210F |
| 4 | 210E | 210F | 210D | 210G |
| 5 | 220B | 220C | 220A | 220D |
| 6 | 220C | 220D | 220B | 220E |
| 7 | 220D | 220E | 220C | 220F |
| 8 | 220E | 220F | 220D | 220G |

FIG. 10A shows a magnetic field in a detection system according to cross-section XA-XA in FIG. 10. As the outside loop 210CF of antenna elements 210C, 210F generates an electro-magnetic field that is in phase with that of the electromagnetic field generated by the internal loop 210DE the field between the antenna loops 210DE and 210CF is weakened, so that a tag does not give a response in that area. As the electro-magnetic field generated by the outside loop 210CF is weaker than that of the inside loop 210DE the electro-magnetic field within the inside loop 210DE remains substantially unchanged.

It is not strictly necessary that a single RF-signal generator is used to activate subsequently each of the first antenna loops. A more costly, but possible solution would be for example to use a separate RF-signal generator for each of the first antenna loops.

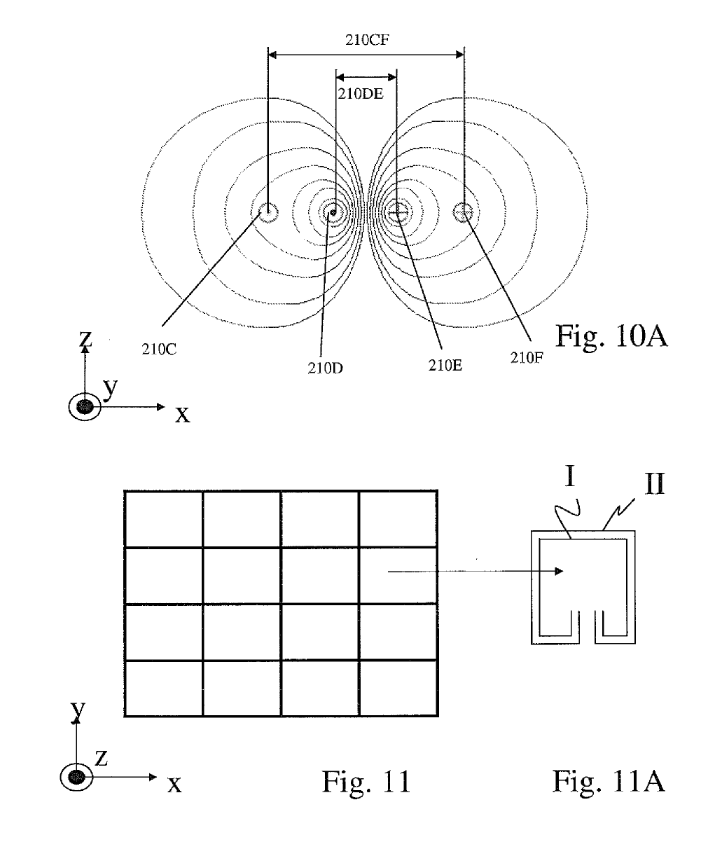

Instead of using mutually orthogonal, crossing antenna loops it would alternatively be possible to have a plurality of mutually neighbouring antenna loops that cover the plane x-y as shown in FIG. 11. Each square of the plane comprises a first antenna loop I enclosed by a second antenna loop II, as shown in FIG. 11A.

It is not necessary that a plurality of first and second antenna loops is present. The invention is also applicable with only a single first and a single second antenna loop. In this way it can be determined reliably whether the RF-tag of an object to be localized is within the zone delimited by the first antenna loop.

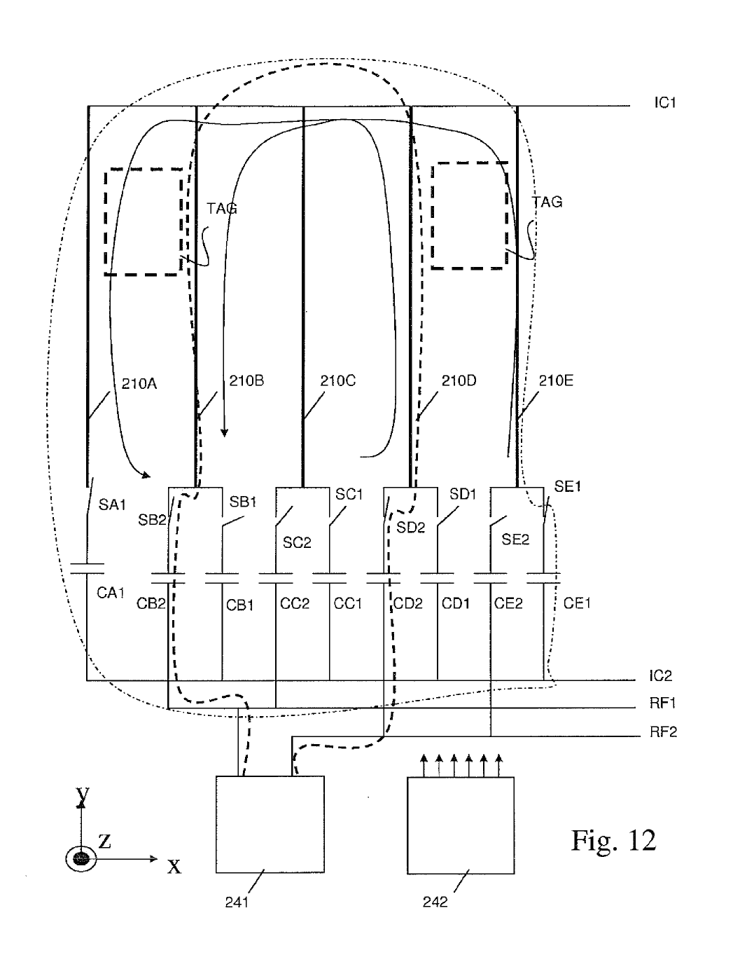

FIG. 12 shows in more detail how antenna elements 210A-210E are coupled to the RF signal generator 241. The remaining antenna elements 210F, 210G, 220A-220G of the array of FIG. 10 are coupled similarly.

As shown in FIG. 12, at least one first antenna loop 210B+210D is dynamically formed from the plurality of parallel elongated antenna elements 210A-210E by switching a first pair of said antenna elements 210B, 210D in series. At least one second antenna loop 210A+210E is dynamically formed by switching a second pair of said antenna elements in series 210A, 210E with each other and with a capacitive impedance formed by capacitors CA1, CE1. The second antenna loop 210A+210E is activated by its magnetic coupling with the first antenna loop 210B+210D. It would alternatively be possible to activate the second antenna loop 210A+210E by a separate RF-generator. However, this would require an accurate control of the signal provided to the second antenna loop. Providing a fixed RF-signal to the second antenna loop could result in over compensation in case the magnetic field of the first antenna loop is weakened by other influences, e.g. by the presence of transponders in the neighbourhood of the first antenna loop. In the present embodiment the magnetic field generated by the second antenna loop is automatically coupled to that of the first antenna loop.

The plurality of antenna elements 210A-210E have a first end that is statically connected to a first inter connect line IC1. The antenna elements 210A-210E have a second end that is coupled via a first switch SA1-SE1 respectively and a first capacitive impedance CA1-CE1 respectively to a second interconnect line IC2. First ones of the antenna elements 210B, 210C have their second end coupled via a second switch SB2, SC2 and a second capacitive impedance CB2, CC2 to a first RF signal supply line RF1 of the RF source 241 and second ones of the antenna elements 210D, 210E have their second end coupled via a second switch SD2, SE2 and a second capacitive impedance CD2, CE2 to a second RF signal supply line RF2 of the RF source 242. During operation the antenna selection controller 242 controls the switches so that at each stage two antenna elements 210B, 210D on both sides of an unenergized central antenna element, here 210C, form a first antenna loop. The antenna selection controller 242 further controls two antenna elements 210A, 210E to form a second antenna loop. One thereof precedes the lowest ranked antenna element 210B of the first antenna loop and one succeeds the highest ranked antenna element 210D of the first antenna loop.

As shown in the example of FIG. 12, the at least second antenna loop 210A+210E formed by antenna elements 210A, 210E is capacitively closed via the elements SA1, CA1, IC2, CE1, SE1 It is further inductively coupled to the first antenna loop 210B+210D formed by antenna elements 210B, 210D. In this way it can be easily achieved that the second antenna loop 210A+210E is provided with an

RF signal that is in phase with that of the RF-signal in the first antenna loop 210B+210D, without necessitating a separate RF signal generator for activating the second antenna loop.

In the sequel a method is described that can be used to tune the capacitances CA1, CB2, CB1, etc to achieve that the RF signal in the second antenna loop is in phase with that of the first antenna loop.

According to a first step of the method a capacitive value of a first capacitive device CB2, CD2 is set, until a maximum response is obtained at the operating frequency of the RFID system, typically 13.56 Mhz. For simplicity the capacitive value of the capacitances CB2, CD2 is symmetrically tuned so that the capacitive value of these capacitances CB2, CD2 is always the same.

In the second step the second antenna loop 210A, 210E is tuned by symmetrically setting a capacitive value of the capacitive devices CA1, CE1, until a maximum response is obtained at a second, higher frequency corresponding approximately to the −3 dB point of the tuned active antenna, the first antenna loop formed by 21B, 210D,

Then the first step is repeated, as tuning the capacitors CA1, CE1 causes a slight shift in the operating frequency of the first antenna loop 210B, 210D.

Subsequently an RFID tag is positioned within a zone inside the passive antenna (the second antenna loop formed by 210A, 210E) and outside the active antenna (the first antenna loop formed by 210B, 210D). After the tag is positioned, i.e. at one of the positions indicated by tag in FIG. 12 the capacitance formed by the capacitive elements CA1, CE1 is tuned symmetrically such that communication with the tag just fails.

In this embodiment, the initial value for the capacitive elements should be in the range of 400-1000 pF, depending on the inductance of the antenna loop and assuming a 13.56 Mhz operating frequency. Other frequencies are also possible, depending on the physical size of the antenna, and will require other capacitive values.

The method is described for the configuration shown in FIG. 12. However, in case the arrangement comprises a larger number of antenna elements, e.g. 210F, . . . , 210X this method can simply be repeated by replacing each element by its next higher ranked element, e.g. 210A by 210B, SA1 by SB1, CA1,

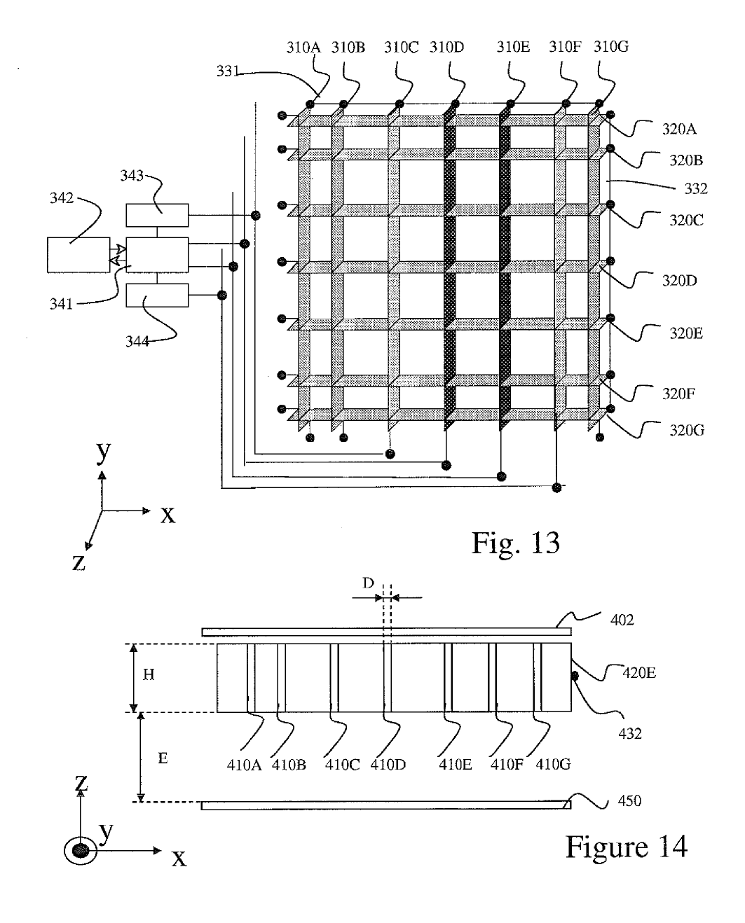

FIG. 13 shows a further embodiment of a system for detecting a position of an object in a plane (position detection system). In said embodiment the inventive measures described with reference to FIGS. 4 and 4A are combined with the inventive measures described with reference to FIG. 10. Parts therein corresponding to those in FIGS. 4 and 4A have a reference number that is 300 higher, and parts therein corresponding to those in FIG. 10 have a reference number that is 100 higher. In this embodiment the antenna loop (e.g. 310D+310E) has at least one antenna element 310D, 310E with a cross-diameter in a direction transverse to the xy-plane that is larger than a cross-diameter aligned with the xy-plane.

Moreover the position detection system has at least a second antenna loop 310C+310F that extends at least partially outside the first antenna loop 310D+310E. An RF-signal generator 341, controlled by controller 342, provides the first antenna loop 310D+310E with an RF signal and the units 343, 344 form a facility for providing the second antenna loop 310C+310F with an RF signal that is in phase with that of the RF-signal in the first antenna loop 310D+310E.As both measures contribute to a sharper transition of the magnetic field strength an even further improvement of the accuracy of the position detection can be achieved.

In some circumstances a tabletop at which the position detection system is positioned may comprise metal parts and therewith influence the operation of the position detection system. This is prevented in a further embodiment of the position detection system according to the invention, shown in FIG. 14. FIG. 14 shows said further embodiment in a cross-section corresponding to the cross-section in FIG. 4A. Parts in FIG. 14 corresponding to those in FIG. 4A have a reference number that is 400 higher. The position detection system shown in FIG. 14 is provided with a conductive layer 450 in a plane substantially parallel to the (detection) plane 402. The plane with the conductive layer 450 is arranged at a distance E from the antenna elements 410A-410G, 420E. The distance E should be larger than the size H of the cross-diameter of the antenna elements transverse to the detection plane 402. By way of example the size H is 10 mm, the distance E is 11 mm and the antennas have a cross-diameter D in the direction of the plane 402 of 0.3 mm. The antenna elements 410A, . . . , 410G are spaced apart with a distance of 20 mm. Likewise similar further antenna elements (not shown) are present that extend along the x-direction of the plane that are also spaced apart by 20 mm, so that detection areas of 20 mm×20 mm are formed. The conductive layer 450, e.g. a conductive foil functions as a ‘shield’. The foil 450 is not directly connected to the antenna circuitry to limit RF currents running via the stray capacitance between antennas and shield, which may influence behavior in a complex, hard to predict, manner. As a result of the shield 450, the material of the tabletop at which the position detection system is placed has no effect on the behavior of the antenna. Preferably the RF-generator drives the antenna elements of the active antenna loop in a differential way and the shield 450 is connected to mass. In that case external influences are strongly minimized.

In an embodiment the shield 450 is created by means of a printed circuit board (PCB) layer and the same PCB is used to provide the interconnections between the antenna elements. In an alternative embodiment the system may be arranged in a metal housing. In another embodiment a non-conductive housing may be used that is provide with a conductive coating, e.g. applied by spray painting.

Although the present invention is described in detail for a game device, the present invention is also suitable for other applications. For instance, objects with built-in RFID tags can be cheaply localized in specific positions on a shelf or at specific terminals of a robotic delivery system, which shelves or terminals are provided with a system according to the present invention.

In the claims the word “comprising” does not exclude other elements or steps, and the indefinite article “a” or “an” does not exclude a plurality. A single component or other unit may fulfill the functions of several items recited in the claims.

The mere fact that certain measures are recited in mutually different claims does not indicate that a combination of these measures cannot be used to advantage. Any reference signs in the claims should not be construed as limiting the scope. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

1. System for detecting a position of an object in a plane, in an operational state comprising
at least one antenna loop aligned with the plane,
an RF signal generator for activating the antenna loop,
wherein the antenna loop has at least one antenna element with a cross-diameter in a direction transverse to the plane that is larger than a cross-diameter in a direction aligned with the plane.

2. System according to claim 1, comprising a plurality of parallel elongated antenna elements, wherein the at least one antenna loop is dynamically formed by switching a pair of said antenna elements in series.

3. System according to claim 2, wherein the plurality of parallel elongated antenna elements have a first end that is statically connected to an interconnect line.

4. System according to claim 1, wherein the antenna elements are formed by blade-like elements.

5. System according to claim 1, wherein the antenna elements are formed by a set of wires that are stacked in a direction transverse to the plane.

6. System for detecting a position of an object in a plane, in an operational state comprising
at least a first antenna loop,
at least a second antenna loop, that extends at least partially outside the first antenna loop,
an RF-signal generator for providing the first antenna loop with an RF signal,
an facility for providing the second antenna loop with an RF signal that is in phase with that of the RF-signal in the first antenna loop.

7. System according to claim 6, characterized in that the at least second antenna loop is capacitively closed, and that it is inductively coupled to the first antenna loop.

8. System according to claim 6, comprising a plurality of parallel elongated antenna elements, wherein the at least one first antenna loop is dynamically formed by switching a first pair of said antenna elements in series and wherein the at least one second antenna loop is dynamically formed by switching a second pair of said antenna elements in series with each other and with a capacitive impedance .

9. System according to claim 2, characterized by a further plurality of parallel elongated antenna elements that are arranged transverse to the plurality of parallel elongated antenna elements.

10. System according to claim 9, wherein the antenna elements of the plurality and the further plurality of parallel elongated antenna elements each are blade like elements.

11. System according to claim 10, wherein the antenna elements of the plurality and of the further plurality are provided with recesses with which said antenna elements grip into each other.

12. System according to claim 11, wherein the plurality and the further plurality of antenna elements have a first end that is statically connected to a first inter connect line and have a second end that is coupled via a first switch and a first capacitive impedance to a second interconnect line and wherein first ones of the antenna elements have their second end coupled via a second switch and a second capacitive impedance to a first RF signal supply line of the RF source and second ones of the antenna elements have their second end coupled via a second switch and a second capacitive impedance to a second RF signal supply line of the RF source.
